(19) United States
(12) Patent Application Publication
(10) Pub. No.: US 2011/0023791 A1
(43) Pub. Date: Feb. 3, 2011

(54) REMOTE POPPER FOR TRAINING EXERCISES

(76) Inventor: John Palmer, Circle Pines, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 12/843,391

(22) Filed: Jul. 26, 2010

Related U.S. Application Data
(60) Provisional application No. 61/229,875, filed on Jul. 30, 2009.

(51) Int. Cl. A01K 15/02

(52) U.S. Cl. 119/719

(57) ABSTRACT

A remotely operable device, capable of creating authentic gunshot sounds, provides a very useful training tool for dog trainers by allowing for simulated gunshots in conjunction with thrown training dummies (or birds). The remotely operable device further provides the ability for a single dog trainer to create a realistic training environment which includes realistic sounds and visual indications. The remotely operable device includes a housing capable of receiving a blank shell, a receiver cooperating with a remote control device operated by the trainer, an striker system which operates in response to a remote actuation signal received by the receiver. The striker system has a striker element and a striker release, where the striker release is activated by a servo which is responsive to signals received by the receiver. Once released, the striker element is spring biased to cause the striker to move into contact with the blank shell, thus causing the blank shell to be fired creating the desired sound. To provide additional safety, the housing further includes a shell cover for containing the blank shell in the housing, while also allowing the striker to contact an appropriate surface of the blank shell to cause the blank shell to fire.

### REFERENCE TO RELATED APPLICATIONS

This application claims the benefit of previously filed U.S. Provisional application 61/229,875, filed Jul. 30, 2009 and entitled “Remote Popper for Training Exercises.”

### BACKGROUND

The present invention relates to a training device used primarily in dog training activities. More specifically, a remote popper is provided to simulate gunshots when conducting training exercises, such as gundog training activities.

During dog training activities, and especially those activities when training for field trials, hunt test and hunting, it is desirable to create realistic training situations. In creating these desired conditions, it is necessary to simulate various sounds and related bird activities. For example, this often involves the use of launchers to throw dummies and/or dead birds into the air, thus simulating both a flying bird, and a bird which has been shot. The associated sounds typically include duck and pheasant calls, typical bird sounds, and the sounds of associated gunshots. In addition, it is desirable to create all of these affects at remote locations, away from the dog.

Remote launchers are nationally utilized for the above-mentioned training exercises. These remote launchers are typically capable of launching single or multiple dummies and/or birds into the air. In certain instances these launchers are manually operated, while other instances utilize remote controls to actuate the launcher.

As an alternative to the remote launchers mentioned above, multiple individuals may be positioned at various locations in the field. In these circumstances the individuals may operate launchers themselves, or may simply throw dummies/birds into the air with a simulated gun shot. In addition, these remotely placed individuals may carry guns of different types in order to simulate appropriate gunshots. For safety purposes, blank rounds are utilized so that no live ammunition is actually fired into the air.

### SUMMARY OF THE INVENTION

In order to provide a more realistic simulation, a remotely operated device provides the ability to include realistic gunshot sounds in conjunction with training exercises. One embodiment of the invention is usable with a remote launcher device, and is operable utilizing the same remote control systems. In this case, the operator can coordinate the launching of dummies/birds with appropriate sounds (gunshots) to create a realistic situation. Alternatively, the device can be used alone where it is inconvenient or inappropriate to require a cooperating remote launcher.

Generally speaking, the preferred embodiment of the present invention includes a shell housing capable of receiving a typical blank shell, along with an actuation device. The actuation device itself includes a mechanical structure necessary to fire the blank, along with an electronic trigger device. The electronic trigger device is configured to receive an actuation signal and thereafter trip a release mechanism. Tripping the release mechanism will cause a physical hammer striker, similar to a typical firing pin, to be directed toward the blank shell. In this manner, the blank shells fire, thereby creating the desired shotgun sound. The configuration and orientation of the various components is specifically designed to ensure safe operation and avoid the risk of injury.

As mentioned above, the various embodiments of present invention contemplate the use of blank shells to create the gunshot sounds. Obviously, this creates a very realistic sound and a very realistic training situation. Creating this realistic simulation greatly enhances the training environment and provides for greater training efficiency. Further, the popper can be mounted or placed in appropriate remote locations, thus creating desired sounds without the need for additional personnel. When incorporated with remote launchers, the combined system allows a single trainer to run their dog through very realistic training exercises.

### BRIEF DESCRIPTION OF THE DRAWINGS

Further objects and advantages of the present invention will be seen by reading the following description, in conjunction with the drawings in which;

FIG. 1 is a side perspective view of the remote popper;

FIG. 2 is a side plan view;

FIG. 3 is a bottom plan view;

FIG. 4 is a bottom perspective view;

FIG. 5 is an end perspective view;

FIG. 6 is a first top perspective view;

FIG. 7 is a second top perspective view; and

FIG. 8 is a block diagram illustrating one embodiment of the remote popper.

### DETAILED DESCRIPTION OF THE PREFERRED EMBODIMENTS

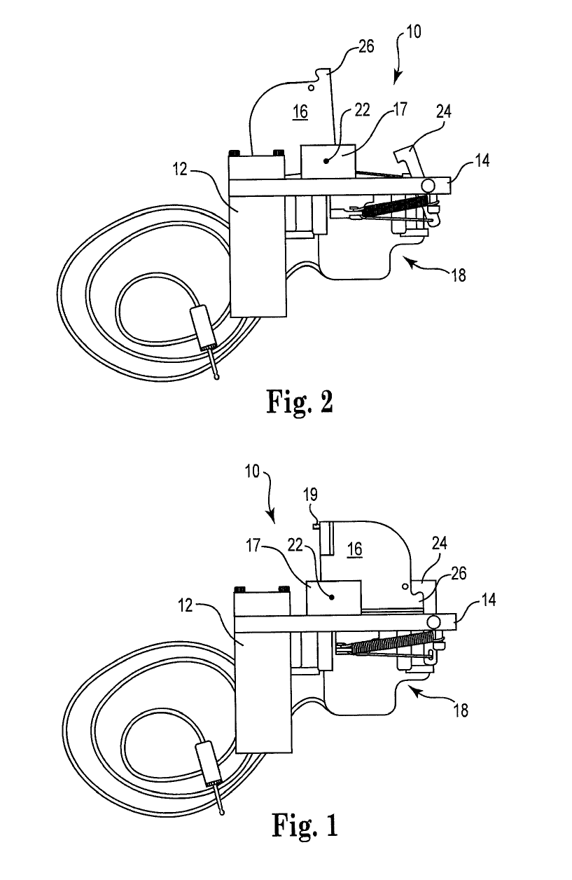

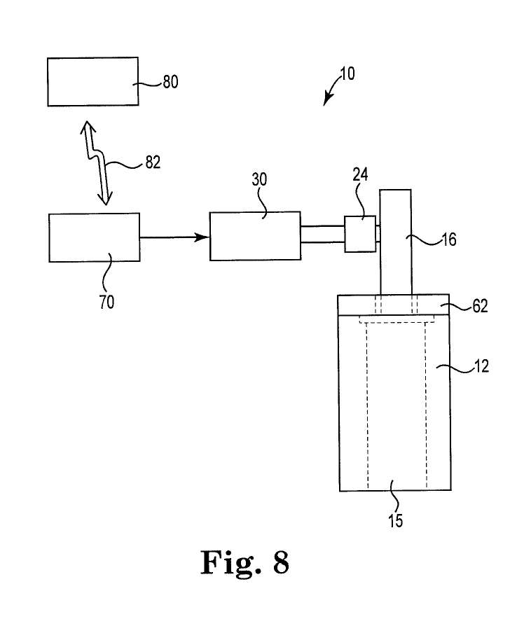

Various views of a preferred embodiment are illustrated in FIGS. 1-7, while a block diagram is illustrated in FIG. 8. More specifically, FIGS. 1 and 2 illustrate a side view of the remote popper 10 in both a cocked orientation (FIG. 1) and an actuated orientation (FIG. 2). As shown, the device generally includes a shell housing 12, a main base 14, a striker 16 and an actuation system 18. Shell housing 12 is configured to receive and contain a blank shell. Naturally, this housing could be modified or changed to accept the various types of blanks, however a blank shotgun shell is typically most appropriate for the intended purposes of the present device.

As mentioned above, FIG. 8 shows a block diagram of one embodiment of remote popper 10. Illustrated in a block diagram format is shell housing 12, which is again configured to receive a blank shell within an opening or chamber 15. Further, striker 16 is generally shown to be adjacent to shell housing 12. As further discussed below, this arrangement simply accommodates the movement of striker 16 to appropriately strike the blank shell, thus firing when desired. Positioned immediately adjacent striker 16 is a striker release mechanism 24, which is effectively operated by a servo 30. Also shown in FIG. 8 is a receiver 70 and a remote control 80. Generally speaking, remote control 80 is utilized to actuate the remote popper. As contemplated, the remote control 80 will be carried by a dog trainer, or an appropriate individual tasked with firing the remote popper at the desired times. A radio signal 82 is transmitted from remote 80 and is received by receiver 70. Upon receipt of the desired signal, receiver 70 will create an actuation signal which is then transmitted to servo 30. The actuation signal consequently causes servo 30 to be actuated, which in this embodiment causes striker release 24 to release striker 16 and fire the blank shell. FIG. 8 further generally illustrates a slide plate 62 which is configured to cover and contain the blank shell in shell housing 12.

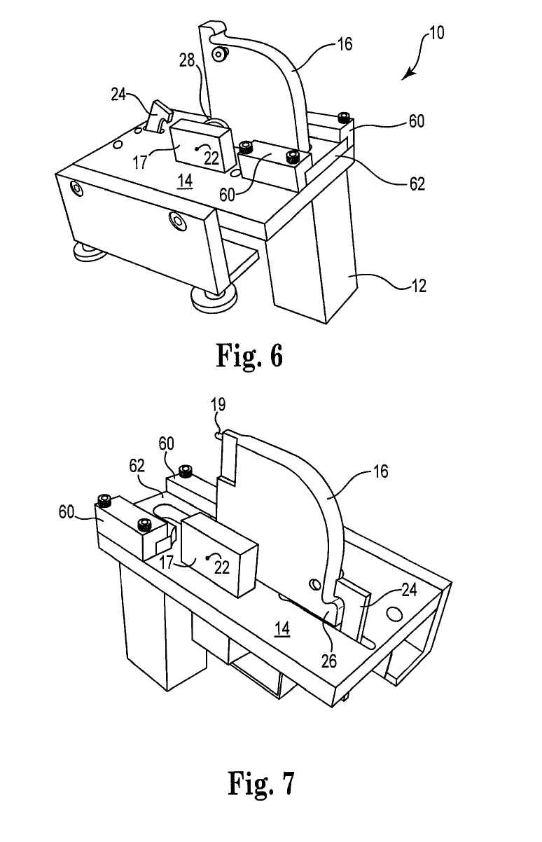

Referring again to FIGS. 1 & 2, striker 16 is supported by a pair of support blocks 17, and rotatable about a pivot axis 22. As illustrated, this connection structure allows appropriate movement of striker 16 from its cocked orientation to its actuated orientation. As best illustrated in FIG. 1, striker 16 is held in its cocked position via a striker release 24 which is attached to main base 14. As further discussed below, striker release 24 is appropriately moved and operated via servo 30 which is also attached to main base 14. Striker release 24 is also attached to main base 14 in a manner to be pivotable about an attachment point. In this manner, striker release 24 can be appropriately moved away from a retaining ledge 26 on striker 16. A biasing spring 28 (better shown in FIG. 6) causes striker 16 to swing into appropriate contact with the blank shell contained in shell housing 12. More specifically, a striker pin 19 will contact the blank shell.

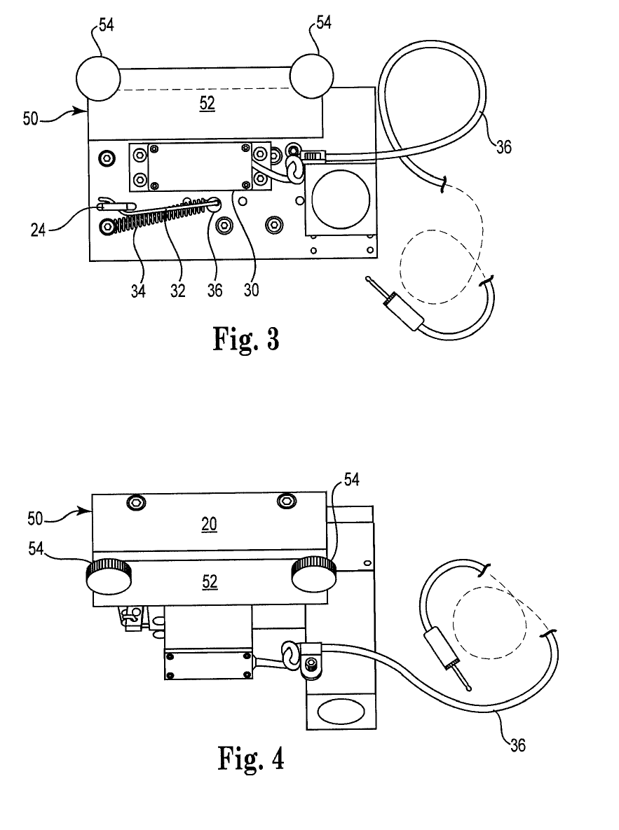

To provide further views of various components, FIG. 3 illustrates a bottom view of the remote popper device 10, while FIG. 4 illustrates a bottom/side perspective view. As best shown in FIG. 3, striker release 24 is coupled to servo 30 via a coupling lever 32. Servo 30 includes an electrical connection 36 capable of receiving an appropriate actuation signal and causing appropriate movement of an actuation arm 36. Upon receipt of the actuation signal, servo 30 will be triggered causing movement of coupling lever 32 and related movement of trigger release 24. In this manner the hammer is released as mentioned above.

In one embodiment, it is contemplated that the above mentioned actuation signal would be produced by a separate receiver 70 capable of cooperating with an appropriate remote control 80. For example, a remote dummy launcher also requires a receiver cooperating with a remote control device in order to receive a remote actuation signal thus causing actuation of the launching device. It is contemplated that the same receiver could be used to receive a second remote actuation signal that is capable of producing the above mention actuation signal which causes operation of servo 30. Alternatively, a stand-alone receiver could be attached to main base 14 to receive a remote signal and thus produce the desired actuation signal for servo 30.

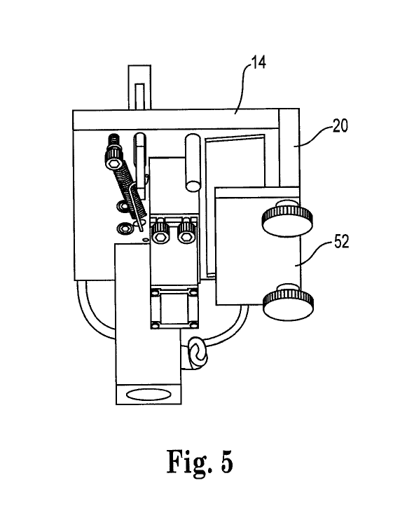

FIGS. 3 and 4 also provide a better view of a mounting structure 50. This mounting structure is also illustrated in an end view shown on FIG. 5. As shown, main base 14 has a side plate 20 and a detachable coupling plate or clamp 52 attached thereto. Coupling plate 52 is removably attached via a pair of thumb screws 54. It is anticipated that coupling plate 52 be easily removed thereby allowing the main base 14 and side plate 20 to be placed adjacent to a frame structure of a cooperating launching device. Coupling plate 52 could then be replaced thereby providing secure attachment of remote popper 10 to any desired structure. As suggested above, it is contemplated that remote popper 10 will advantageously be attached to a remote dummy launcher. In this manner, appropriately timed sounds of gunshots can be added to the launcher, thus creating more realistic training simulations.

In use, remote popper 10 is typically armed or cocked manually. This is achieved by manually rotating striker 16 into its cocked position and engaged with striker release 24. Striker release 24 and retaining ledge 26 are specifically configured to positively interconnect with one another and require a predetermined amount of force by servo 30 to cause disengagement. Specifically, these two components include engagable structures which mate with one another (as best illustrated in FIGS. 1 and 7).

As generally suggested above, shell housing 12 is specifically design and configured to hold a typical blank shell. FIGS. 6 and 7 provide a better view of the actual holding mechanisms utilized. As shown in the previous figures, shell housing 12 includes a hollow cylinder configured to tightly contain the above-referenced blank shell. Further, remote popper 10 includes a pair of slide clamps 60 which cooperate with a slide plate 62 to contain the top portion of blank shell within shell housing 12. As will be anticipated, slide plate 62 is allowed to move laterally above shell housing 12. Once a blank shell is positioned within shell housing 12, slide plate 62 is then allowed to slide over the top of a portion of the blank shell, thereby providing upper containment. Further, slide plate 62 includes a recess or opening in the center which easily allows striker pin 16 to make contact with the blank shell. In this manner, the blank shell is contained while also providing the ability to be fired.

As generally illustrated above, the components provided allow for the efficient operation of a remote popper which is capable of creating realistic sound simulation in a training exercise. Further, the components are uniquely designed and configured to officially carry out the desired operations, while also being rugged, compact, and easily useable.

As discussed above, mounting structure 50 is configured to provide adaptable mounting capabilities. Those skilled in the art will recognize that several variations or adaptations can be made which allow for many different mounting schemes. For example, the remote popper device 10 could easily be directly bolted to a supporting structure, or could be clamped using various clamping techniques. In many cases, these alternatives are not as convenient for users, and thus may not as attractive. That said, it is clearly contemplated that these variations also form part of applicant's invention.

In addition to the above contemplated variations, it is also contemplated that the housing could easily be reconfigured to contain multiple blank shells, and have multiple striker systems. In this alternative embodiment, a receiver would be capable of receiving multiple remote signals, and producing desired actuation signals for multiple servos.

Although certain embodiments have been described in the discussion above, applicants contend that the present invention similarly covers additional modifications and variations. Applicant claims all such modifications in variations coming within the scope and spirit of the following claims.

1. A training device for adding realistic gunshot sounds to training exercises, the device comprising:
a shell housing configured to receive a blank shell;
a striker system attached to the shell housing, the striker system having a spring loaded striker pin and a striker release, wherein the striker pin is movable between a cocked position and an actuated position with the bias of a spring urging the striker pin to the actuated position, the striker release interacting with the striker pin to hold the striker pin in the cocked position which is also against the bias of the spring, wherein movement from the cocked position to the actuated position causes the firing of the blank shell; and
an actuator coupled to the striker release to move the striker release from a first position where the striker release is retaining the striker in the cocked position, and a second position where the striker is released.

2. The training device of claim 1 wherein the actuator is a servo having a movable actuator arm coupled to the striker release, the servo responsive to a received actuation signal which causes movement of the actuator arm and a corresponding release of the striker.

3. The training device of claim 1 wherein the shell housing and the striker pin are supported by a main base, and wherein the striker pin is rotatable between the cocked position and the actuated position.

4. The training device of claim 2 wherein the actuation signal is produced by a wireless receiver device electrically coupled to the servo.

5. The training device of claim 1 further comprising a mounting structure capable of attaching the device to a remote launching device.

6. The training device of claim 3 further comprising a blank shell holding mechanism having a slide plate movable over a portion of the blank shell and a slide support structure attached to the base plate, the slide plate further including a recess thereby allowing the striker pin to make contact with the blank shell when moved to the actuated position.

7. A remote training device for producing gunshot sounds, in response to a remote actuation signal produced by a remote control, comprising:
a receiver in communication with the remote control;
a housing having a shell chamber configured to contain a blank shell;
a striker mechanism positioned adjacent to the shell chamber, the striker mechanism having a striker, a striker release in communication with the receiver, wherein the striker is capable of being held in a first position by the striker release, and wherein the striker is moved to a second position when the striker release is activated in response to the receiver receiving the remote actuation signal.

8. The remote training device of claim 7 wherein the striker is hingedly coupled to the housing and wherein the striker mechanism further comprises a spring biasing the striker to the second position.

9. The remote training device of claim 8 wherein the striker has a striker pin positioned to strike the blank shell when the striker is moved to the second position.

10. The remote training device of claim 7 wherein the striker release comprises a hinged hook capable of retaining the striker in the first position when the striker release is in a retaining position and releasing the striker when moved to a release position.

11. The remote training device of claim 10 wherein the hinged hook is moved between the retaining position and the release position by a servo.

12. The remote training device of claim 11 wherein the servo is actuated by a signal received from the receiver.

13. The remote training device of claim 7 further comprising a shell retainer positioned adjacent the shell housing, the shell retainer movable to capture the blank shell.

14. The remote training device of claim 13 wherein the shell retainer comprises a slide plate having an opening which allows the striker to make contact with an upper surface of the blank shell.

15. The remote training device of claim 7 further comprising a mounting structure for releasably mounting the housing to a bar thereby securely holding the housing for operation.
